(19) United States
(12) Patent Application Publication
(10) Pub. No.: US 2026/0155551 A1
(43) Pub. Date: Jun. 4, 2026

(54) DEVICE FOR REMOVING GAS OF SECONDARY BATTERY AND METHOD OF MANUFACTURING SECONDARY BATTERY USING THE SAME

(71) Applicant: Samsung SDI Co., Ltd., Yongin-si (KR)

(72) Inventors: Hyunju Kim, Yongin-si (KR); Donghyun Kim, Yongin-si (KR)

(73) Assignee: Samsung SDI Co., Ltd., Yongin-si (KR)

(21) Appl. No.: 19/364,070

(22) Filed: Oct. 21, 2025

(30) Foreign Application Priority Data
Dec. 3, 2024 (KR) 10-2024-0177882

(51) Int. Cl. H01M 50/609

(52) U.S. Cl. CPC H01M 50/609

(57) ABSTRACT

The present disclosure relates to a device for removing gas of a secondary battery and a method of manufacturing the secondary battery using the same. The device for removing gas of the secondary battery according to the present disclosure includes a vacuum hopper that is provided to be insertable into an electrolyte inlet of an assembled secondary battery, and a vacuum generating unit that is connected to the vacuum hopper and selectively brings an inside of the vacuum hopper into a vacuum state and a vacuum release state, wherein the vacuum hopper suctions a portion of an electrolyte injected into and gas in the secondary battery in the vacuum state.

### CROSS-REFERENCE TO RELATED APPLICATIONS

This present application claims priority to and the benefit under 35 U.S.C. § 119(a)-(d) of Korean Patent Application No. 10-2024-0177882, filed on Dec. 3, 2024, in the Korean Intellectual Property Office, the entire disclosure of which is incorporated herein by reference.

### FIELD

The present disclosure relates to a gas removal device for removing gas generated when a secondary battery is manufactured, and a method of manufacturing a secondary battery using the same.

### BACKGROUND

Secondary batteries are batteries that can be charged and discharged, unlike primary batteries that cannot be recharged. Generally, secondary batteries include an electrode assembly composed of a positive electrode plate, a negative electrode plate, and a separator, and an exterior material (battery can or case) that accommodates the electrode assembly. The types of electrode assembly may be classified into a wound type and a stack type according to the stacked form of the electrode plates and separator. The wound type electrode assembly is called a jelly roll, and the stack type electrode assembly is called a stack. Further, the types of secondary batteries may be classified into a pouch type, a cylindrical type, a prismatic type, and the like according to the material and shape of an exterior material.

When a secondary battery is manufactured, a process of accommodating an electrode assembly in a battery can, electrically connecting the electrode assembly to external terminals, injecting an electrolyte, and then pre-charging the electrode assembly is performed. Problems in which gas may be generated by a chemical reaction during the pre-charging process and the pre-injected electrolyte overflows may occur. Such problems cause degradation of the product performance of secondary batteries, and thus it is necessary to provide an improvement direction to secure product reliability.

The herein information disclosed in this Background section is for enhancement of understanding of the background of the present disclosure, and therefore, it may contain information that does not constitute related (or prior) art.

### SUMMARY

The present disclosure is directed to providing a gas removal device for removing gas capable of removing gas generated during a process of manufacturing a secondary battery, and a method of manufacturing a secondary battery using the same.

According to aspects of the present disclosure, there is provided a device for removing gas of an assembled secondary battery, which includes a vacuum hopper that is provided to be insertable into an electrolyte inlet of the secondary battery, and a vacuum generating unit that is connected to the vacuum hopper and selectively brings an inside of the vacuum hopper into a vacuum state and a vacuum release state, wherein the vacuum hopper suctions a portion of an electrolyte injected into and gas in the secondary battery in the vacuum state.

According to aspects of the present disclosure, there is provided a method of manufacturing a secondary battery using the device for removing gas of the secondary battery, which includes assembling an electrode assembly and a battery can, injecting an electrolyte through an electrolyte inlet of the battery can, and performing charging/discharging in a state in which the vacuum hopper is inserted into the electrolyte inlet.

Aspects and features of the present disclosure are not limited to those described herein, and other aspects and features not specifically mentioned herein will be clearly understood by those skilled in the art from the description of the present disclosure

### BRIEF DESCRIPTION OF THE DRAWINGS

The following drawings attached to the present specification illustrate embodiments of the present disclosure and further describe aspects and features of the present disclosure together with the detailed description of the present disclosure. Thus, the present disclosure should not be construed as being limited to the drawings, in which:

FIGS. 1 and 2 are schematic views illustrating electrode assemblies of secondary batteries according to some embodiments of the present disclosure;

FIG. 3 is a schematic view illustrating an exterior of a prismatic secondary battery according to some embodiments of the present disclosure;

FIG. 4 is a view for describing a method of manufacturing a secondary battery according to embodiments of the present disclosure;

FIG. 5 is a view for describing an electrolyte injection process and a pre-charging process according to embodiments of the present disclosure;

FIG. 6 is a view for describing a charging/discharging process according to embodiments of the present disclosure;

FIG. 7 is a view for describing a method of manufacturing a secondary battery according to embodiments of the present disclosure;

FIG. 8 is a view for describing an electrolyte injection process and a charging/discharging process according to embodiments of the present disclosure;

FIG. 9 is a schematic view illustrating a device for removing gas according to embodiments of the present disclosure;

FIG. 10 is a view for describing an example of a pressing process according to embodiments of the present disclosure; and

FIGS. 11 and 12 are schematic views illustrating a device for removing gas according to still embodiments of the present disclosure.

### DETAILED DESCRIPTION

Hereinafter, embodiments of the present disclosure will be described, in detail, with reference to the accompanying drawings. The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her disclosure in the best way.

The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed herein could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

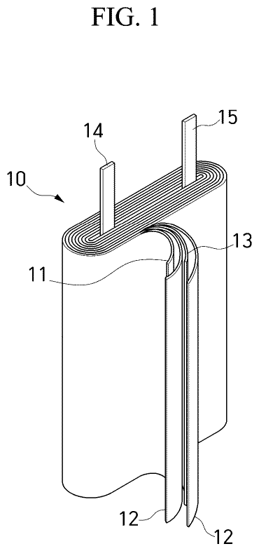

FIGS. 1 and 2 are schematic views illustrating electrode assemblies of secondary batteries according to some embodiments of the present disclosure. FIG. 1 illustrates a wound type electrode assembly, and FIG. 2 illustrates a stack type electrode assembly.

As illustrated, an electrode assembly 10 may be formed by winding or stacking a stack of a first electrode plate 11, a separator 12, and a second electrode plate 13, each of which are formed as thin plates or films. Although the electrode assembly 10 may be a wound type electrode assembly illustrated in FIG. 1 or a stack type electrode assembly illustrated in FIG. 2, the shape of the electrode assembly 10 is not limited in the present disclosure. In addition, the electrode assembly 10 may be a Z-stack electrode assembly in which a positive electrode plate and a negative electrode plate are inserted into both sides (e.g., opposite sides) of a separator, which is then bent (or folded) into a Z-stack. The first electrode plate 11 of the electrode assembly 10 may act as a negative electrode, and the second electrode plate 13 may act as a positive electrode. Of course, the reverse is also possible.

The first electrode plate 11 may be formed by applying (e.g., coating or depositing) a first electrode active material, such as graphite or carbon, onto a first electrode substrate formed of a metal foil, such as copper, a copper alloy, nickel, or a nickel alloy. The first electrode plate 11 may include a first electrode tab 14 (e.g., a first uncoated portion), which is a region to which the first electrode active material is not applied. The first electrode tab 14 may be connected to an external first terminal. In some embodiments, when the first electrode plate 11 is manufactured, the first electrode tab 14 may be formed by being cut in advance to protrude to (or protrude from) one side of the electrode assembly 10, or the first electrode tab 14 may protrude to one side of the electrode assembly 10 more than (e.g., farther than or beyond) the separator 12 without being separately cut.

The second electrode plate 13 may be formed by applying (e.g., coating or depositing) a second electrode active material, such as a transition metal oxide, onto a second electrode substrate formed of a metal foil, such as aluminum or an aluminum alloy. The second electrode plate 13 may include a second electrode tab 15 (e.g., a second uncoated portion), which is a region to which the second electrode active material is not applied. The second electrode tab 15 may be connected to an external second terminal. In some embodiments, the second electrode tab 15 may be formed by being cut in advance to protrude to the other side (e.g., the opposite side) of the electrode assembly 10 when the second electrode plate 13 is manufactured, or the second electrode plate 13 may protrude to the other side of the electrode assembly more than (e.g., farther than or beyond) the separator 12 without being separately cut.

The separator 12 prevents a short-circuit between the first electrode plate 11 and the second electrode plate 13 while allowing movement of lithium ions therebetween. The separator 12 may be made of, for example, a polyethylene film, a polypropylene film, a polyethylene-polypropylene film, or the like.

In some embodiments, the electrode assembly 10 may be accommodated in a case along with an electrolyte. The electrode assembly 10 may be accommodated in a cylindrical or prismatic metal casing.

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α (}0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α2); LiₐNi_{b}Co_{c}L¹_{d}GₑO₂ (0.90≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the herein formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x≤2), a Si-based alloy, or a combination thereof.

The silicon-carbon composite may be a composite of silicon and amorphous carbon. According to embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are stacked on each other.

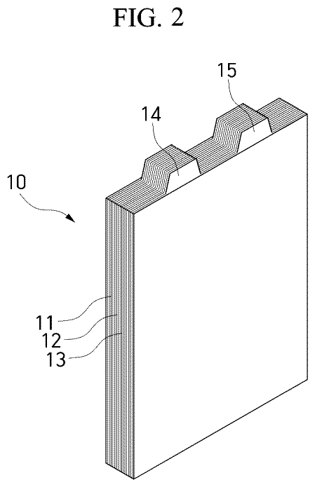

FIG. 3 is a schematic view illustrating an exterior of a prismatic secondary battery according to some embodiments of the present disclosure.

A battery can 22 may provide a space in which the electrode assembly 10 illustrated in FIGS. 1 and 2 is accommodated and form an overall exterior of a secondary battery 20. The battery can 22 may be formed of a conductive metal such as SUS, aluminum, an aluminum alloy, nickel-plated steel, or the like.

A first terminal 24 and a second terminal 26 may be electrically connected to a first electrode tab 14 and a second electrode tab 15 of the electrode assembly 10 accommodated inside the battery can 22, respectively, and may be installed to be exposed to the outside of the battery can 22. The battery can 22 may include an electrolyte inlet 28, and an electrolyte may be injected into the battery can 22 through the electrolyte inlet 28. Although not illustrated, a vent that opens due to gas generated inside the secondary battery 20 and discharges the gas (degassing) may be formed at any location of the battery can 22.

A process of forming the secondary battery 20 may include an assembly process of assembling the electrode assembly 10 and the battery can 22, and an activation process of activating the secondary battery 20 to impart electrical characteristics. The activation process may include performing charging and discharging of the secondary battery 20 through a charging/discharging unit under conditions required for activation. Further, the activation process may include a pressing process to fix a position of the secondary battery 20, pressing the secondary battery 20 to allow electrode plates to be close to each other, and allowing a gap between the electrode plates of the electrode assembly 10 to be uniformly impregnated with the electrolyte.

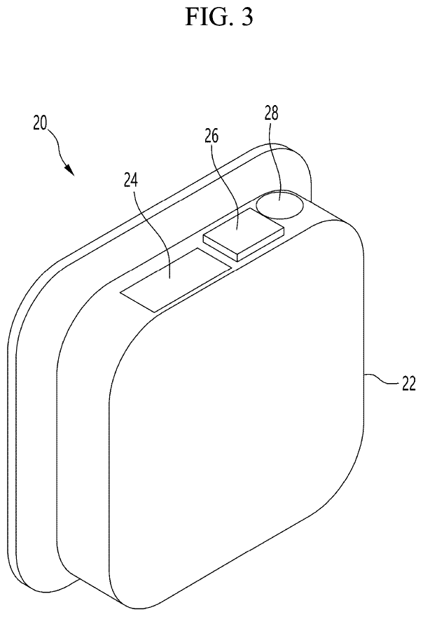

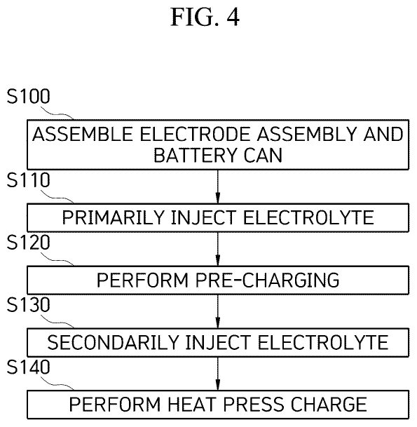

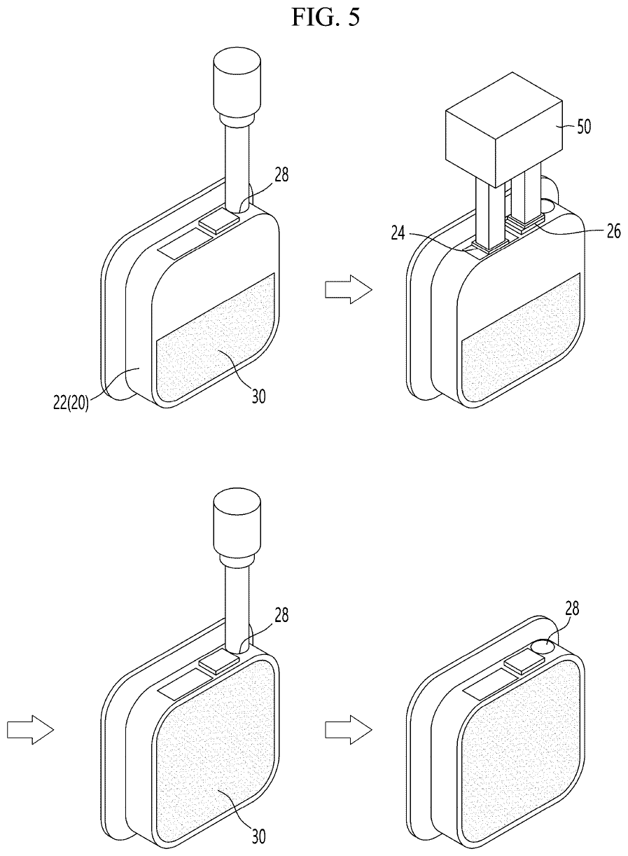

FIG. 4 is a view for describing a method of manufacturing a secondary battery according to embodiments of the present disclosure. FIG. 5 is a view for describing an electrolyte injection process and a pre-charging process according to embodiments of the present disclosure. FIG. 6 is a view for describing a charging/discharging process according to embodiments of the present disclosure.

Referring to FIGS. 4 and 5 along with FIG. 3, the method of manufacturing the secondary battery according to embodiments of the present disclosure may include a battery can assembly operation S100, a primary electrolyte injection operation S110, a pre-charging operation S120, a secondary electrolyte injection operation S130, and a charging/discharging operation S140.

The battery can assembly operation S100 of assembling a secondary battery 20 may be performed. As described herein, the battery can assembly operation S100 may include a process of accommodating an electrode assembly 10 in a battery can 22, electrically connecting electrode tabs 14 and 15 of the electrode assembly 10 to terminals 24 and 26 of the battery can 22, and then performing sealing of the battery can 22.

The primary electrolyte injection operation S110 may be performed. In the electrolyte injection operation, an electrolyte 30 may be primarily injected through an electrolyte inlet 28 of the assembled battery can 22. In this case, the amount of the electrolyte 30 injected may be smaller than the amount required for a final secondary battery product. Preferably, the amount of the electrolyte 30 primarily injected may be set to approximately 70% of the amount required for the final secondary battery product, but the present disclosure is not limited thereto.

After the primary injection of the electrolyte, the electrolyte inlet 28 may be temporarily closed. After the electrolyte inlet 28 is temporarily closed, an aging operation may be performed. The aging operation is a process of making conditions for the electrolyte to evenly permeate a gap between the electrode plates of the electrode assembly 10 so that lithium ions move smoothly.

The pre-charging operation S120 may be performed. The pre-charging operation is a process of pre-charging the electrode assembly 10 by supplying power to the terminals 24 and 26 outside the battery can 22. In the pre-charging operation, lithium ions move to a negative electrode and react with the electrolyte, and a solid electrolyte interface (SEI) film is formed on a surface of the negative electrode.

The secondary electrolyte injection operation S130 may be performed. In the secondary electrolyte injection operation, the temporarily closed electrolyte inlet 28 may be opened, and the electrolyte 30 may be injected through the opened electrolyte inlet 28. The amount of the electrolyte 30 to be secondarily injected may be a design amount required for the final secondary battery product. After the secondary electrolyte injection operation S130 is performed, the electrolyte inlet 28 may be completely closed. As necessary, the aging operation may be performed after the electrolyte inlet 28 is completely closed.

Referring further to FIG. 6, the charging/discharging operation S140 may be performed. The charging/discharging operation is a process of performing charging and discharging of the battery can 22 through a charging/discharging unit 50 under conditions required for activation. In the charging/discharging operation S140, charging/discharging may be performed multiple times as necessary. The charging/discharging operation S140 may perform a heat press charge (HPC).

More specifically, the charging/discharging operation S140 may further include a heat press operation. The heat press operation is a process of pressing the battery can 22 to allow the electrode plates to be close to each other and allow the gap between the electrode plates of the electrode assembly 10 to be uniformly impregnated with the electrolyte 30, and by performing this process, the lifting of the electrode plates may be suppressed and the coupling force of the electrode plates can be strengthened.

The pressing process may be performed through a pressing jig 60. The pressing jig 60 may include a first pressing plate 61 and a second pressing plate 63 that face each other. For example, the pressing process is a process of applying pressure to both sides of the battery can 22 while the battery can 22 is interposed between the first and second pressing plates 61 and 63. The pressing process may be performed simultaneously with the charging/discharging process. The pressing jig 60 may be about 4 kgf to 13 kgf per unit area (e.g., per 1 cm²). That is, the electrode assembly 10 may be pressed at about 4 kgf/cm² to 13 kgf/cm². However, the present disclosure is not limited thereto. Pads may be attached to or formed integrally with pressing surfaces of the first and second pressing plates 61 and 63. The pads may be provided to prevent damage to the battery can 22 due to the pressure provided during the pressing process and maintain flatness. The pads may be formed of silicone, vukollan, or the like, but the present disclosure is not limited thereto.

The pressing process may be performed together with a heating process. The heating process may promote the activation of the electrolyte and ions by applying heat to the electrode assembly 10 to further increase the coupling force of the electrode plates and increase the charging efficiency. A heating temperature may range from 0° C. to about 110° C., but the present disclosure is not limited thereto.

As necessary, the pressing process and the heating process may be performed together with the pre-charging process in the pre-charging operation S120. Through these processes, a secondary battery may be manufactured.

As described herein, in the method of manufacturing the secondary battery according to some embodiments of the present disclosure, the electrolyte injection process is divided into two stages and performed. That is, in the pre-charging operation, gas is generated inside the battery can 22 during the process of pre-charging the battery can 22 due to a chemical reaction such as the formation of an SEI film or the like, and the electrode assembly 10 expands. In this case, the overflow of the electrolyte may occur due to the generated gas, the expansion of the electrode assembly 10, etc. Therefore, in the method of manufacturing the secondary battery according to some embodiments of the present disclosure, a primary electrolyte injection process of filling the battery can 22 with some of the electrolyte before the pre-charging operation, and a secondary electrolyte injection process of filling the battery can 22 with the remaining electrolyte after the pre-charging operation are performed separately.

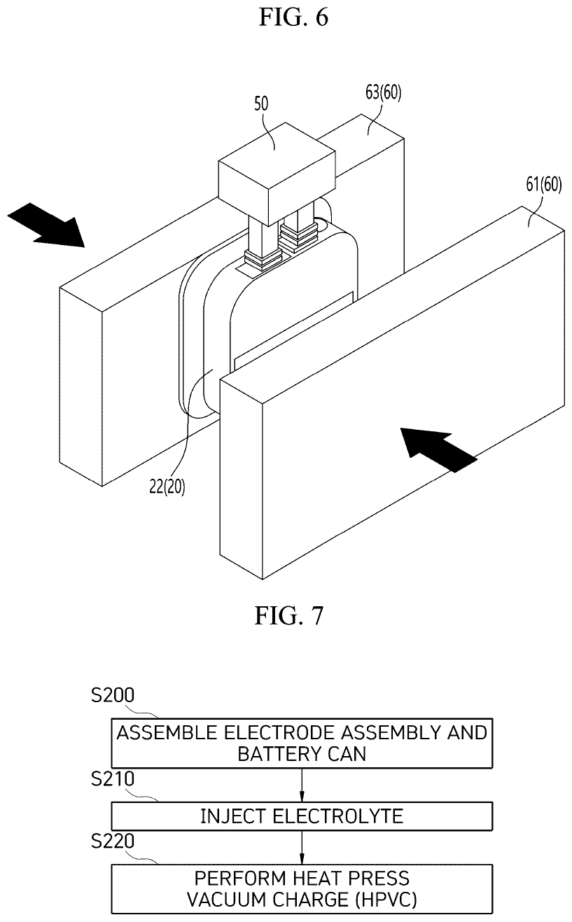

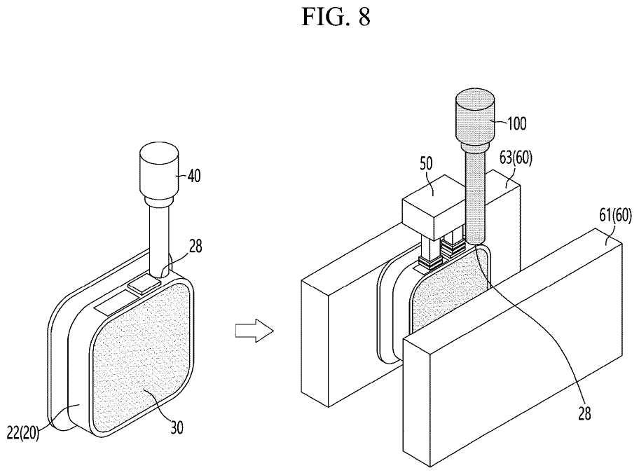

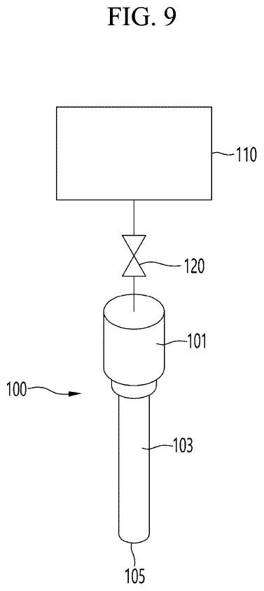

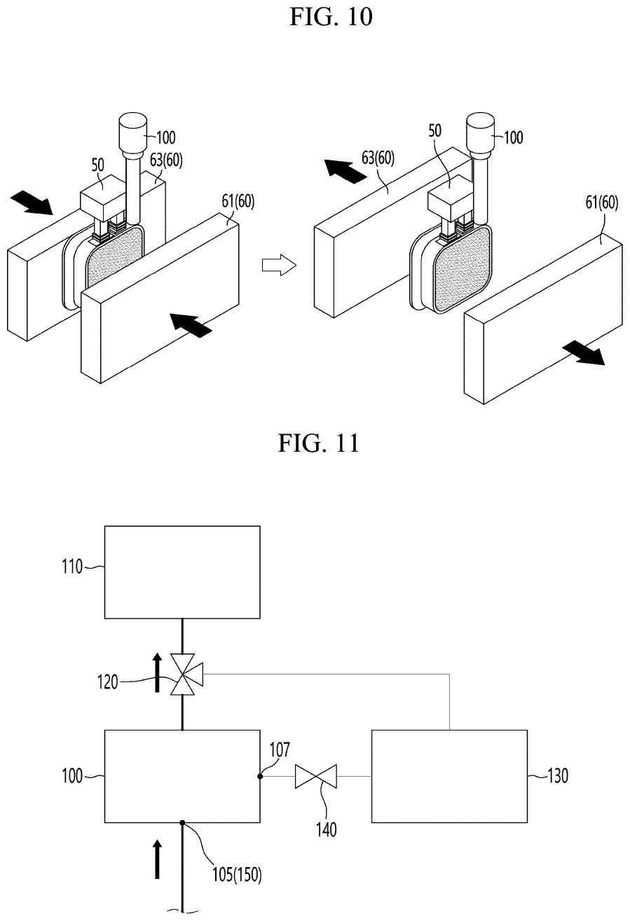

FIG. 7 is a view for describing a method of manufacturing a secondary battery according to embodiments of the present disclosure. FIG. 8 is a view for describing an electrolyte injection process and a heat press vacuum charge process according to embodiments of the present disclosure. FIG. 9 is a schematic view illustrating a device for removing gas according to embodiments of the present disclosure. FIG. 10 is a view for describing an example of a pressing process according to embodiments of the present disclosure.

Referring to FIGS. 7 and 8 along with FIG. 3, the method of manufacturing the secondary battery according to embodiments of the present disclosure may include a battery can assembly operation S200, an electrolyte injection operation S210, and a charging/discharging operation S220.

The assembly operation S200 of assembling a secondary battery 20 may be performed. As described herein, the assembly operation S200 may include a process of accommodating an electrode assembly 10 in a battery can 22, electrically connecting the electrode tabs 14 and 15 of the electrode assembly 10 to terminals 24 and 26 of the battery can 22, and then performing sealing of the battery can 22.

The electrolyte injection operation S210 may be performed. In the electrolyte injection operation S210, an electrolyte 30 may be injected through an opened electrolyte inlet 28 so that the electrode assembly 10 is impregnated with the electrolyte. The amount of the electrolyte 30 to be injected may be a design amount required for a final secondary battery product. In the method of manufacturing the secondary battery according to embodiments of the present disclosure, unlike in the embodiment of the present disclosure described herein, the electrolyte injection operation may not be divided. After the electrolyte injection operation S210, the subsequent operation may be performed while the electrolyte inlet 28 is not closed but opened.

The charging/discharging operation S220 may be performed. The charging/discharging operation S220 may be a process of performing charging and discharging of the battery can 22 through a charging/discharging unit 50 under conditions required for activation. In the charging/discharging operation S220, lithium ions move to a negative electrode and react with the electrolyte, and an SEI film is formed on a surface of the negative electrode. Charging/discharging may be performed multiple times as necessary. The charging/discharging operation S220 may be a heat press vacuum charge (HPVC).

The charging/discharging operation S220 may include a gas removal operation. During the charging process, gas is generated due to a chemical reaction such as the formation of an SEI film or the like. The gas removal operation may be a process of removing the gas contained in the electrolyte and/or the gas inside the battery can 22 using a vacuum hopper 100 during the charging process.

Referring further to FIG. 9, the gas removal process may be performed using a device for removing gas. The device for removing gas may include a vacuum hopper 100 and a vacuum generating unit 110 for bringing the vacuum hopper 100 into a vacuum state. In response to the operation of the vacuum generating unit 110, an inside of the vacuum hopper 100 may be switched to a vacuum state or a vacuum release state. The vacuum generating unit 110 may include a vacuum pump. The vacuum pressure may be adjusted or may be preset.

More specifically, the vacuum hopper 100 may include a vacuum hopper pipe 101 and a vacuum nozzle 103. The vacuum hopper pipe 101 may be a portion that accommodates some of the suctioned electrolyte in a state in which the provided vacuum is maintained. The vacuum nozzle 103 may be connected to one end of the vacuum hopper pipe 101 and may be provided to be inserted into the electrolyte inlet 28 of the battery can 22. The vacuum nozzle 103 may include an inlet 105 formed at one end thereof, and the inlet 105 may be inserted into the electrolyte inlet 28 of the battery can 22 to function as a path through which the electrolyte is introduced.

The vacuum hopper 100 and the vacuum nozzle 103 may communicate with each other to form a flow path through which the electrolyte flows. The vacuum nozzle 103 may be in close contact with the electrolyte inlet 28 while inserted into the electrolyte inlet 28 and may have a shape to maintain a closed state. Since the vacuum nozzle 103 is closed while inserted into the electrolyte inlet 28, the vacuum state of the inside of the vacuum hopper pipe 101 may be maintained in response to the operation of the vacuum generating unit 110.

The device for removing gas may further include a switching unit 120 that opens/closes a line connecting the vacuum hopper 100 to the vacuum generating unit 110. The switching unit 120 may be a vacuum valve (or vacuum check valve), but the present disclosure is not limited thereto. In response to the on/off operation of the switching unit 120, the inside of the vacuum hopper 100 may be switched to a vacuum state or a vacuum release state.

The gas removal process may include a first operation of coupling the vacuum hopper 100 to the electrolyte inlet 28 of the battery can 22, and a second operation of removing gas generated during the charging process while suctioning a portion of the electrolyte contained in the battery can 22 through the vacuum hopper 100 in a state in which the vacuum generating unit 110 brings the vacuum hopper 100 into a vacuum state. The gas may be removed by being discharged to the outside. For example, the vacuum hopper pipe 101 may further include an exhaust manifold (not illustrated) that discharges the gas suctioned in the vacuum state.

The charging process may be performed together with (simultaneously) the second operation of the gas removal process or during the second operation. Accordingly, since the electrolyte that overflows during the charging process does not leak to the outside but is introduced into the vacuum hopper 100, electrical failures such as a short and the like caused by the electrolyte leaking to the outside of the battery can 22 can be prevented.

The gas removal process may further include a third operation of releasing vacuum in the vacuum hopper 100 in a state in which the gas is removed, to re-introduce at least a portion of the electrolyte accommodated in the vacuum hopper 100 into the battery can 22. That is, since the electrolyte introduced into the vacuum hopper 100 in the gas removal operation is re-introduced into the battery can 22, the electrolyte may be reused without being discarded, and thus an unnecessary electrolyte replenishment operation may not be performed. As necessary, the second operation and the third operation may be performed sequentially multiple times.

The charging/discharging operation S220 may further include a pressing operation. the pressing operation is a process of pressing the battery can 22 to allow the electrode plates to be close to each other and allowing the gap between the electrode plates of the electrode assembly 10 to be uniformly impregnated with the electrolyte 30, and by performing this process, the lifting of the electrode plates may be suppressed and the coupling force of the electrode plates can be strengthened.

The pressing process may be performed through a pressing jig 60. The pressing jig 60 may include a first pressing plate 61 and a second pressing plate 63 that face each other. For example, the pressing process is a process of applying pressure to both sides of the battery can 22 while the battery can 22 is interposed between the first and second pressing plates 61 and 63. The pressing process may be performed simultaneously with the charging/discharging process. The pressing process may be performed together with a heating process. The heating process may promote the activation of the electrolyte and ions by applying heat to the electrode assembly 10 to further increase the coupling force of the electrode plates and increase the charging efficiency.

The pressing process may be performed together with (simultaneously) the second operation of the gas removal process described herein or during the second operation. Accordingly, since the electrolyte that overflows during the pressing process does not leak to the outside but is introduced into the vacuum hopper 100, electrical failures such as a short and the like caused by the electrolyte leaking to the outside of the battery can 22 can be prevented. Further, since the pressing process is performed together with the charging/discharging process, the expansion of the electrode assembly 10 may be limited during the charging process, and thus deformation that exceeds the dimensional range and/or tolerance required in response to the final specifications of the secondary battery can be prevented. Further, the method of manufacturing the secondary battery according to embodiments of the present disclosure may allow the process operations to be reduced by not dividing the electrolyte injection operation into multiple stages compared to embodiments of the present disclosure, and thus process efficiency and convenience may be improved.

Referring further to FIG. 10, preferably, the pressing process (and heating process) may be performed only in some of the charging/discharging process. For example, the pressing process may be performed in an initial charging operation for forming an SEI film (left of FIG. 10), and the pressing process may not be performed in an operation for performing charging/discharging multiple times according to the activation conditions (right of FIG. 10). However, by continuously performing the gas removal process while the charging/discharging process continues, the gas generated in the charging/discharging process may be continuously removed. A method of manufacturing a secondary battery according to an exemplary embodiment of the present disclosure may selectively perform the pressing process only in some of the charging/discharging process (preferably, an initial charging stage), the heat press process is continuously performed, and thus a problem of increased internal resistance of the secondary battery, which reduces product reliability and stability, can be prevented.

After the charging/discharging operation S220, a process of closing the electrolyte inlet 28 may be performed, and the method of manufacturing the secondary battery may be completed.

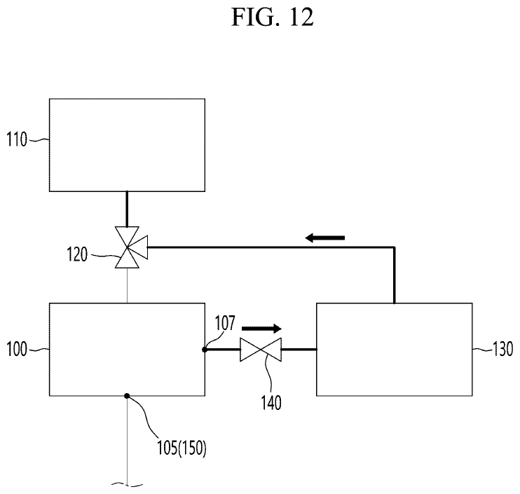

FIGS. 11 and 12 are schematic views illustrating a device for removing gas according to still embodiments of the present disclosure.

Referring to FIGS. 11 and 12, at least a portion of an electrolyte suctioned in a vacuum hopper 100 in a vacuum state may be discharged to the outside. That is, in the charging/discharging operation S220, the electrolyte suctioned in the vacuum hopper 100 may be introduced into the battery can 22 or discharged to the outside after gas removal. As necessary, a portion of the electrolyte suctioned in the vacuum hopper 100 may be introduced into the battery can 22 and the remining electrolyte may be discharged to the outside. For example, the electrolyte that overflows while the pressing process is performed may not be required to be re-introduced into the battery can 22. In this case, the electrolyte suctioned in the vacuum hopper 100 is discharged to the outside and attempts to be re-introduced into the battery can 22, thereby preventing the electrolyte from leaking.

To this end, the device for removing gas may further include a discharge unit 130, a discharge line that connects the discharge unit 130 to the vacuum hopper 100, and a discharge switching unit 140 that selectively opens/closes the discharge line. The discharge unit 130 may be connected to the vacuum hopper 100 to suction the electrolyte from which the gas has been removed after being introduced into the vacuum hopper 100 and discharge the electrolyte. The discharge unit 130 may be connected to the vacuum generating unit 110 to accommodate the electrolyte suctioned from the vacuum hopper 100 in a state in which the vacuum provided in response to the operation of the vacuum generating unit 110 is maintained and may discharge the electrolyte to the outside. Preferably, the electrolyte discharge operation of the discharge unit 130 may be performed in a state in which the vacuum is released. The discharge unit 130 and the vacuum generating unit 110 may be selectively connected to each other through the switching unit 120. The switching unit 120 may be a three-way valve.

The vacuum hopper 100 may further include an outlet 107 formed in at least one of the vacuum hopper pipe 101 and the vacuum nozzle 103, and an opening/closing unit 150 the opens/closes the inlet 105 of the vacuum nozzle 103. The outlet 107 may be connected to the discharge unit 130 through the discharge line. The discharge line may be selectively opened/closed through the discharge switching unit 140. The discharge switching unit 140 may be a vacuum valve (or vacuum check valve), but the present disclosure is not limited thereto. In response to the on/off operation of the discharge switching unit 140, the inside of the vacuum hopper 100 and the discharge unit 130 may be switched to a vacuum state or a vacuum release state.

In response to the manipulation operation of the opening/closing unit 150, the inlet 105 may be selectively opened/closed, and the amount of electrolyte flowing between the vacuum hopper 100 and the battery can 22 may be determined. The opening/closing unit 150 may be selected as one known mechanical structure capable of blocking the flow of the electrolyte or may be a valve.

Hereinafter, a method of selectively operating the device for removing gas will be described.

### Gas Removal Process, Electrolyte and Gas Suction, FIG. 11

The switching unit 120 is switched to a first state to connect the vacuum generating unit 110 to the vacuum hopper 100 (the vacuum generating unit 110 and the discharge unit 130 are disconnected), the opening/closing unit 150 is switched to open the inlet 105 of the vacuum hopper 100, and the discharge switching unit 140 is switched to disconnect the discharge unit 130 and the vacuum hopper 100→the vacuum generating unit 110 is operated to form the vacuum in the vacuum hopper 100→the electrolyte is suctioned, and the gas is removed.

### Gas Removal Process, Discharge of Electrolyte Accommodated in Vacuum Hopper to the Outside, FIG. 12

The switching unit 120 is switched to a second state to connect the vacuum generating unit 110 to the vacuum hopper 100 (the vacuum generating unit 110 and the vacuum hopper 100 are disconnected), the opening/closing unit 150 is switched to disconnect the inlet 105 of the vacuum hopper 100, and the discharge switching unit 140 is switched to connect the discharge unit 130 to the vacuum hopper 100→the vacuum generating unit 110 is operated to form the vacuum in the vacuum hopper 100 and the discharge unit 130→the electrolyte is suctioned and discharged.

The device for removing gas may further include a control unit. The control unit may execute one or more instructions. The control unit may selectively control the vacuum generating unit 110, the switching unit 120, the discharge switching unit 140, at least, and the opening/closing unit 150 in the gas removal process, thereby controlling the switching of the vacuum state and/or the flow of the electrolyte.

According to the present disclosure, since a device for removing gas can be used to remove gas generated during a charging/discharging process, problems such as electrolyte overflow and electrical defects such as a short and the like caused by conventional gas generation can be reduced.

Further, according to the present disclosure, since an electrolyte injection operation cannot be divided into multiple stages to reduce the number of processes, process efficiency and convenience can be improved.

Although the present disclosure has been described herein with respect to embodiments thereof, the present disclosure is not limited thereto. Various modifications and variations can be made thereto by those skilled in the art within the spirit of the present disclosure as defined by the appended claims and their equivalents.

What is claimed is:

1. A device for removing gas of an assembled secondary battery, comprising:
a vacuum hopper that is provided to be insertable into an electrolyte inlet of the secondary battery; and
a vacuum generating unit that is connected to the vacuum hopper and selectively brings an inside of the vacuum hopper into a vacuum state and a vacuum release state,
wherein the vacuum hopper suctions a portion of an electrolyte injected into and gas in the secondary battery in the vacuum state.

2. The device as claimed in claim 1, wherein the vacuum hopper discharges the suctioned electrolyte to the secondary battery in the vacuum release state.

3. The device as claimed in claim 1, further comprising a switching unit that selectively opens/closes a line that connects the vacuum hopper to the vacuum generating unit.

4. The device as claimed in claim 3, wherein the vacuum hopper further comprises:
an inlet through which the electrolyte of the secondary battery is introduced; and
an opening/closing unit that selectively opens/closes the inlet.

5. The device as claimed in claim 4, further comprising:
a discharge unit that is selectively connected to the vacuum hopper and the vacuum generating unit;
a discharge line that connects the vacuum hopper to the discharge unit; and
a discharge switching unit that selectively opens/closes the discharge line,
wherein the switching unit is switched to a first state to connect the vacuum hopper to the vacuum generating unit or switched to a second state to connect the discharge unit to the vacuum generating unit.

6. The device as claimed in claim 5, wherein the vacuum generating unit forms a vacuum in the vacuum hopper in a state in which the switching unit is switched to the first state, the opening/closing unit is switched to open the inlet, and the discharge switching unit is switched to block the discharge line.

7. The device as claimed in claim 5, wherein the vacuum generating unit forms a vacuum in the discharge unit and the vacuum hopper in a state in which the switching unit is switched to the second state, the opening/closing unit is switched to block the inlet, and the discharge switching unit is switched to open the discharge line.

8. The device as claimed in claim 5, wherein further comprising a control unit configured to selectively control the vacuum generating unit, the switching unit, the discharge switching unit, and the opening/closing unit to control switching between the vacuum state and the vacuum release state and flow of the electrolyte.

9. A method of manufacturing a secondary battery using the device for removing gas of the secondary battery as claimed in claim 1, the method comprising:
assembling an electrode assembly and a battery can;
injecting an electrolyte through an electrolyte inlet of the battery can; and
performing charging/discharging in a state in which the vacuum hopper is inserted into the electrolyte inlet.

10. The method as claimed in claim 9, wherein the performing of the charging/discharging further comprises:
in a state in which the vacuum generating unit brings the vacuum hopper into a vacuum state, suctioning a portion of the electrolyte accommodated in the battery can through the vacuum hopper and removing gas generated in the charging process.

11. The method as claimed in claim 10, wherein the gas removal operation further comprises:
releasing the vacuum state of the vacuum hopper in a state in which the gas is removed and re-introducing at least a portion of the electrolyte accommodated in the vacuum hopper into the battery can.

12. The method as claimed in claim 11, wherein the gas removal operation is performed sequentially multiple times.

13. The method as claimed in claim 10, wherein the gas removal operation comprises discharging the electrolyte accommodated in the vacuum hopper to an outside in a state in which the gas is removed.

14. The method as claimed in claim 10, wherein the performing of the charging/discharging further comprises a pressing operation of pressing the battery can.

15. The method as claimed in claim 14, wherein the gas removal operation is continuously performed during the performing of the charging/discharging, and
the pressing operation is selectively performed only during part of the performing of the charging/discharging.

16. The method as claimed in claim 14, wherein the performing of the charging/discharging further comprises a heating operation of applying heat to the battery can.

17. The method as claimed in claim 9, wherein, in the injecting of the electrolyte, an amount of the electrolyte to be injected is set to a design amount required for a final secondary battery.

18. The method as claimed in claim 9, wherein, in the performing of the charging/discharging, a charging/discharging unit is connected to the battery can and charging/discharging is performed multiple times.
